(19) United States
(12) Patent Application Publication
(10) Pub. No.: US 2021/0097762 A1
(43) Pub. Date: Apr. 1, 2021

(54) Effective Streaming of Augmented-Reality Data from Third-Party Systems

(71) Applicant: Facebook Technologies, LLC, Menlo Park, CA (US)

(72) Inventors: Vadim Victor Spivak, Redwood City, CA (US); Bernhard Poess, Redmond, WA (US)

(21) Appl. No.: 16/584,501

(22) Filed: Sep. 26, 2019

(51) Int. Cl. G06T 19/00; G06F 8/61

(52) U.S. Cl. CPC G06T 19/006; G06T 2200/24; G06F 8/61

(57) ABSTRACT

In one embodiment, a method includes receiving an augmented-reality object and an associated display rule from each of a plurality of third-party systems, receiving one or more signals associated with a current view of an environment of a first user from a client system associated with the first user, selecting at least one of the augmented-reality objects received from the plurality of third-party systems based on the one or more signals and the display rule associated with the selected augmented-reality object, and sending instructions for presenting the selected augmented-reality object with the current view of the environment to the client system.

### TECHNICAL FIELD

This disclosure generally relates to virtual reality and augmented reality.

### BACKGROUND

Virtual reality (VR) is an experience taking place within a computer-generated reality of immersive environments can be similar to or completely different from the real world. Applications of virtual reality can include entertainment (i.e. gaming) and educational purposes (i.e. medical or military training). Other distinct types of VR style technology include augmented-reality and mixed reality. Currently standard virtual reality systems use either virtual reality headsets or multi-projected environments to generate realistic images, sounds and other sensations that simulate a user's physical presence in a virtual environment. Virtual reality typically incorporates auditory and video feedback but may also allow other types of sensory and force feedback through haptic technology.

Augmented reality (AR) is an interactive experience of a real-world environment where the objects that reside in the real-world are enhanced by computer-generated perceptual information, sometimes across multiple sensory modalities, including visual, auditory, haptic, somatosensory, and olfactory. The overlaid sensory information can be constructive (i.e. additive to the natural environment) or destructive (i.e., masking of the natural environment) and is seamlessly interwoven with the physical world such that it is perceived as an immersive aspect of the real environment. Augmented-reality is used to enhance natural environments or situations and offer perceptually enriched experiences. With the help of advanced AR technologies (e.g. adding computer vision and object recognition) the information about the surrounding real world of the user becomes interactive and digitally manipulatable.

### SUMMARY OF PARTICULAR EMBODIMENTS

In particular embodiments, a reality-stream server may efficiently stream augmented-reality data to a client system such as AR glasses for different applications using reality-stream. The generation of the augmented-reality data may be based on contextual information associated with the client system. In particular embodiments, different applications may be useful for a user to explore his/her surroundings. However, installing lots of applications on a client system such as AR glasses may be unrealistic as these client systems may operate on limited computing power, which cannot afford many applications running on them. To address the above issue, the embodiments disclosed herein may enable application-providers, in other words third-party content providers, to register with the reality-stream server for streaming services, which may also enrich user experience with the client system, e.g., AR glasses. The user may not need to install those applications. Instead, when the reality-stream server obtains information such as location and context via the AR glasses, the server may determine what information associated with the applications may be useful for the user and then stream augmented-reality data based on such information to the user. As a result, the user may enjoy the augmented-reality data associated with different applications without the burden of the increased computing power on the client system. Although this disclosure describes streaming particular data via a particular system in a particular manner, this disclosure contemplates streaming any suitable data via any suitable system in any suitable manner.

In particular embodiments, the reality-stream server may receive, from each of a plurality of third-party systems, an augmented-reality object and an associated display rule. The reality-stream server may then receive, from a client system associated with a first user, one or more signals associated with a current view of an environment of the first user. In particular embodiments, the reality-stream server may select at least one of the augmented-reality objects received from the plurality of third-party systems based on the one or more signals and the display rule associated with the selected augmented-reality object. The reality-stream server may further send, to the client system, instructions for presenting the selected augmented-reality object with the current view of the environment.

Embodiments of the invention may include or be implemented in conjunction with an artificial reality system. Artificial reality is a form of reality that has been adjusted in some manner before presentation to a user, which may include, e.g., a virtual reality (VR), an augmented-reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

The embodiments disclosed herein are only examples, and the scope of this disclosure is not limited to them. Particular embodiments may include all, some, or none of the components, elements, features, functions, operations, or steps of the embodiments disclosed herein. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1 illustrates an example diagram flow of streaming augmented-reality data for a user.

FIG. 2 illustrates an example method for streaming augmented-reality data.

FIG. 3 illustrates an example social graph.

FIG. 4 illustrates an example computer system.

### DESCRIPTION OF EXAMPLE EMBODIMENTS

Effective Streaming of Augmented-Reality Data from Third-Party Systems

In particular embodiments, a reality-stream server may efficiently stream augmented-reality data to a client system such as AR glasses for different applications using reality-stream. The generation of the augmented-reality data may be based on contextual information associated with the client system. In particular embodiments, different applications may be useful for a user to explore his/her surroundings. However, installing lots of applications on a client system such as AR glasses may be unrealistic as these client systems may operate on limited computing power, which cannot afford many applications running on them. To address the above issue, the embodiments disclosed herein may enable application-providers, in other words third-party content providers, to register with the reality-stream server for streaming services, which may also enrich user experience with the client system, e.g., AR glasses. The user may not need to install those applications. Instead, when the reality-stream server obtains information such as location and context via the AR glasses, the server may determine what information associated with the applications may be useful for the user and then stream augmented-reality data based on such information to the user. As a result, the user may enjoy the augmented-reality data associated with different applications without the burden of the increased computing power on the client system. Although this disclosure describes streaming particular data via a particular system in a particular manner, this disclosure contemplates streaming any suitable data via any suitable system in any suitable manner.

In particular embodiments, the reality-stream server may receive, from each of a plurality of third-party systems, an augmented-reality object and an associated display rule. The reality-stream server may then receive, from a client system associated with a first user, one or more signals associated with a current view of an environment of the first user. In particular embodiments, the reality-stream server may select at least one of the augmented-reality objects received from the plurality of third-party systems based on the one or more signals and the display rule associated with the selected augmented-reality object. The reality-stream server may further send, to the client system, instructions for presenting the selected augmented-reality object with the current view of the environment.

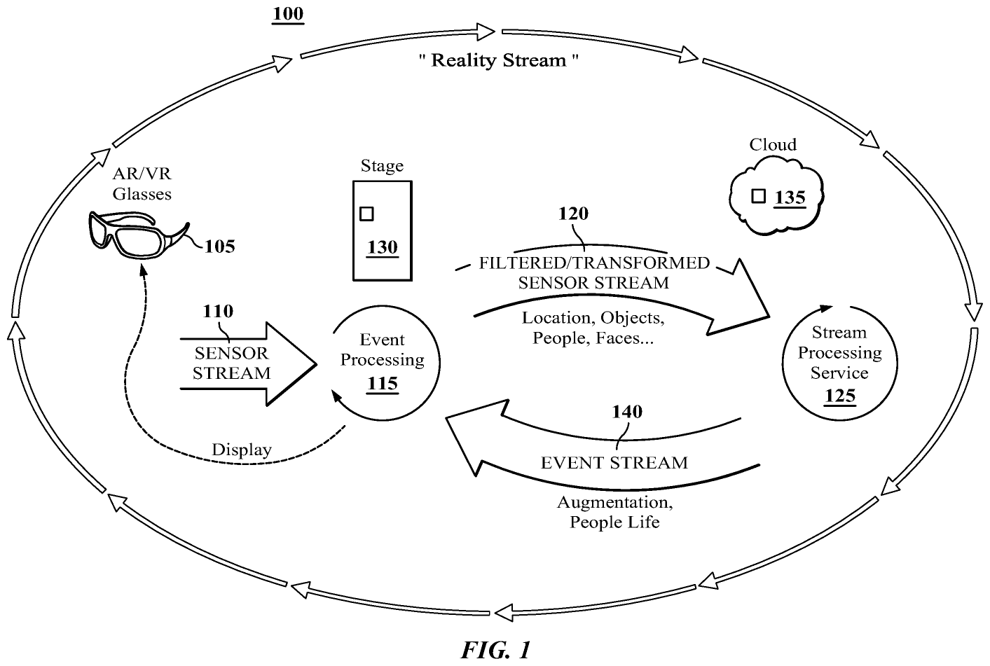

FIG. 1 illustrates an example diagram flow 100 of streaming augmented-reality data for a user. In particular embodiments, a user may wear AR/VR glasses 105 as a smart client system to get useful data. The AR/VR glasses 105 may capture one or more signals, in other words sensor stream 110 (e.g., pictures, videos, or audio), based on one or more sensors. The sensor stream 110 may be sent to an event processing module 115. The event processing module 115 may analyze what events are associated with the sensor stream 110, e.g., arriving at a restaurant. The event processing module 115 may additionally filter or transform the sensor stream to extract key information such as location, objects, people, faces, etc., that are associated with the sensor stream 110. The event processing module 115 may further send the filtered/transformed sensor stream 120 to a stream processing module 125. During the event processing, the current status of the reality stream generation may be stored in a stage unit 130. The stream processing service module 125 may communicate with a cloud computing platform 135 to retrieve relevant streaming data, i.e., augmented-reality objects, for the user. The augmented-reality objects may be provided by a plurality of third-party systems. In particular embodiments, each of the plurality of third-party systems may be associated with a third-party content provider. Each third-party content provider may be registered to the one or more computing systems, i.e., the reality-stream server disclosed herein. The cloud computing platform 135 may have information of which third-party content providers have registered with the reality-stream server to stream their augmented-reality data to end users. The cloud computing platform 135 may also have other information such social graphs, which may be useful for determining what event stream data should be sent to the user. Based on the accessed information from the cloud computing platform 135, the stream processing service module 125 may generate event stream 140, which may include reality augmentation and people information. Such event stream 140 may be sent back to the event processing module 115. Upon receiving the event stream 140, the event processing module 115 may process it so that the event stream 115 can be displayed to the user via the AR/VR glasses 105 effectively.

In particular embodiments, the reality-stream server may determine what augmented-reality data may be most relevant to the user based on the one or more signals including location, time, social graph, available content, the way the user may interact with the augmented-reality data, etc. As a result, it may stream augmented-reality data to AR glasses for the user without overwhelming the user by only showing the user the most relevant data to enrich user experience with efficiency. As an example and not by way of limitation, when a user wearing AR glasses gets close to a restaurant, the reality-stream server may stream augmented-reality object such as a famous dish of this restaurant to the AR glasses. The augmented-reality object of the dish may be provided by a third-party system associated with a third-party content provider. Instead of having a corresponding third-party application running on the client system with expensive computations, the reality-stream server may showcase the augmentation via the AR glasses as long as the third-party content provider is registered with the server. As another example and not by way of limitation, the reality-stream server may leverage social context, e.g., a dish the user's friend has shared, to stream augmented-reality object of the shared dish to the VR glasses of the user.

In particular embodiments, the one or more signals may comprise one or more of location information of the environment, social graph information associated with the environment, social graph information associated with the first user, contextual information associated with the environment, or time information. As an example and not by way of limitation, the location information of the environment may indicate the user is at a movie theater, based on which the server may select a trailer of a movie now playing as the augmented-reality object. As another example and not by way of limitation, the environment may be Times Square and the social graph information associated with the environment may indicate most people took pictures of Times Square. Accordingly, the server may select a picture of Times Square as the augmented-reality object. As another example and not by way of limitation, the user may be at a shopping mall with many merchandisers, but the social graph information associated with the user indicates that the user checked in a particular bakery many times before. As a result, the server may select augmented-reality object such as a picture of a new cake provided by this bakery from augmented-reality objects provided by all the merchandisers in the shopping mall. As another example and not by way of limitation, the user may be at Stanford University. The social graph information associated with the user may indicate the user has a high social graph affinity with Stanford Law School (e.g., the user attended the Law School). As a result, the server may select augmented-reality object such as a picture of a newly published book by Stanford Law School. As another example and not by way of limitation, the user may be at a museum and the contextual information associated with the environment may indicate that the museum is having a temporary exhibition. Accordingly, the server may select augmented-reality objects such as a virtual tour of the temporary exhibition. As another example and not by way of limitation, the user may be at office and the time information may indicate that it is early morning. Correspondingly, the server may select augmented-reality objects such as calendar information and work schedule.

In particular embodiments, the augmented-reality object may comprise one or more of an interactive digital element, a visual overlay, or a sensory projection. The augmented-reality object may be two-dimensional (2D) or three-dimensional (3D). The augmented-reality object may even include animated objects. In particular embodiments, the augmented-reality object may be augmented onto real physical objects. The reality-stream server may further receive, from the client system, one or more user interactions with the selected augmented-reality object from the first user.

In particular embodiments, client systems like AR glasses usually do not have enough computation power on for multiple applications to execute tasks of generating augmented-reality data efficiently. However, it is important to provide augmented-reality data quickly to the client system of a user for good user experience. Using the reality-stream server to stream augmented-reality data towards the AR glasses based on location and context (e.g., social context) captured by the AR glasses of the user may well address the aforementioned limitation as no applications are required to run on the AR glasses. As an example and not by way of limitation, a user may be walking towards a direction. By using the reality-stream server, the augmented-reality data may be pre-loaded in a radius around the user so that when the user physically gets to a certain place, the augmented-reality data may be displayed via the AR glasses to the user immediately without any delay.

In particular embodiments, the reality-stream server may generate, for each of the plurality of third-party systems, a declarative model. The reality-stream server may then receive, via the declarative model from the corresponding third-party system, one or more preferences for one or more types of augmented-reality objects. In particular embodiments, selecting the at least one of the augmented-reality objects received from the plurality of third-party systems may be further based on the one or more preferences received from each third-party system. As a result, the reality-stream server may only stream the data a third-party system declared to the user. As an example and not by way of limitation, Instagram may declare to stream augmented-reality data if the user is tagged in a picture/video posted by the user's friend.

In particular embodiments, the reality-stream server may generate, for at least one of the plurality of third-party systems, a discovery model. The reality-stream server may then send, to the client system, a prompt via the discovery model. The prompt may comprise an executable link for installing a third-party application associated with the at least one third-party system. As an example and not by way of limitation, without installing a particular gaming application a user may not see a cartoon character from the game in augmented reality. The discover model may enable the user to see such cartoon character via the AR glasses when his/her friend is playing this game even if the user did not install the application. The user may be prompted to download and install the application if he/she wants to play the game. As a result, the discovery model may provide a user a whole different way of discovering content and applications.

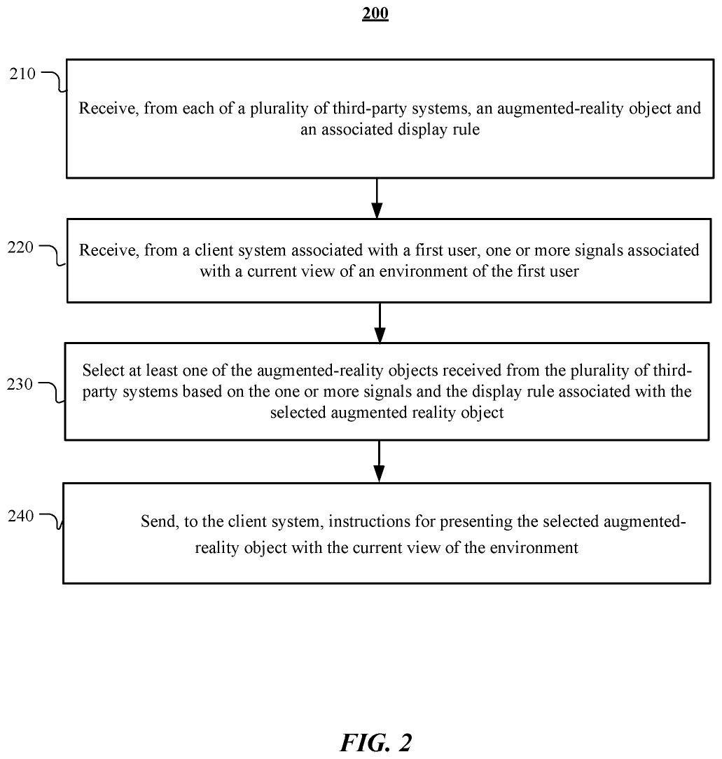

FIG. 2 illustrates an example method 200 for streaming augmented-reality data. The method may begin at step 210, where the reality-stream server may receive, from each of a plurality of third-party systems, an augmented-reality object and an associated display rule. At step 220, the reality-stream server may receive, from a client system associated with a first user, one or more signals associated with a current view of an environment of the first user. At step 230, the reality-stream server may select at least one of the augmented-reality objects received from the plurality of third-party systems based on the one or more signals and the display rule associated with the selected augmented reality object. At step 240, the reality-stream server may send, to the client system, instructions for presenting the selected augmented-reality object with the current view of the environment. Particular embodiments may repeat one or more steps of the method of FIG. 2, where appropriate. Although this disclosure describes and illustrates particular steps of the method of FIG. 2 as occurring in a particular order, this disclosure contemplates any suitable steps of the method of FIG. 2 occurring in any suitable order. Moreover, although this disclosure describes and illustrates an example method for streaming augmented-reality data including the particular steps of the method of FIG. 2, this disclosure contemplates any suitable method for streaming augmented-reality data including any suitable steps, which may include all, some, or none of the steps of the method of FIG. 2, where appropriate. Furthermore, although this disclosure describes and illustrates particular components, devices, or systems carrying out particular steps of the method of FIG. 2, this disclosure contemplates any suitable combination of any suitable components, devices, or systems carrying out any suitable steps of the method of FIG. 2.

Embodiments of the invention may include or be implemented in conjunction with an artificial reality system. Artificial reality is a form of reality that has been adjusted in some manner before presentation to a user, which may include, e.g., a virtual reality (VR), an augmented-reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers

### Social Graphs

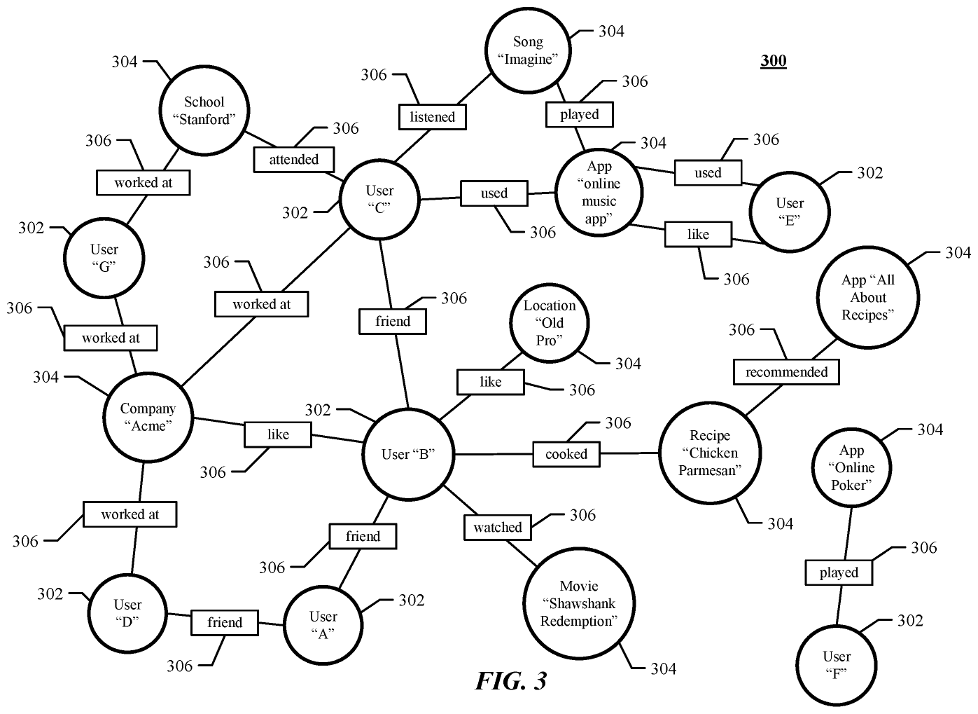

FIG. 3 illustrates example social graph 300. In particular embodiments, there may be one or more social graphs 300 stored in one or more data stores. In particular embodiments, social graph 300 may include multiple nodes—which may include multiple user nodes 302 or multiple concept nodes 304—and multiple edges 306 connecting the nodes. Each node may be associated with a unique entity (i.e., user or concept), each of which may have a unique identifier (ID), such as a unique number or username. Example social graph 300 illustrated in FIG. 3 is shown, for didactic purposes, in a two-dimensional visual map representation. In particular embodiments, a reality-stream server, a client system, or a third-party system may access social graph 300 and related social-graph information for suitable applications. The nodes and edges of social graph 300 may be stored as data objects, for example, in a data store (such as a social-graph database). Such a data store may include one or more searchable or queryable indexes of nodes or edges of social graph 300.

In particular embodiments, a user node 302 may correspond to a user of an online social network. As an example and not by way of limitation, a user may be an individual (human user), an entity (e.g., an enterprise, business, or third-party application), or a group (e.g., of individuals or entities) that interacts or communicates with or over the online social network. In particular embodiments, when a user registers for an account with the online social network, a social-networking system may create a user node 302 corresponding to the user, and store the user node 302 in one or more data stores. Users and user nodes 302 described herein may, where appropriate, refer to registered users and user nodes 302 associated with registered users. In addition or as an alternative, users and user nodes 302 described herein may, where appropriate, refer to users that have not registered with social-networking system. In particular embodiments, a user node 302 may be associated with information provided by a user or information gathered by various systems, including the social-networking system. As an example and not by way of limitation, a user may provide his or her name, profile picture, contact information, birth date, sex, marital status, family status, employment, education background, preferences, interests, or other demographic information. In particular embodiments, a user node 302 may be associated with one or more data objects corresponding to information associated with a user. In particular embodiments, a user node 302 may correspond to one or more webpages.

In particular embodiments, a concept node 304 may correspond to a concept. As an example and not by way of limitation, a concept may correspond to a place (such as, for example, a movie theater, restaurant, landmark, or city); a website (such as, for example, a website associated with social-network system or a third-party website associated with a web-application server); an entity (such as, for example, a person, business, group, sports team, or celebrity); a resource (such as, for example, an audio file, video file, digital photo, text file, structured document, or application) which may be located within social-networking system or on an external server, such as a web-application server; real or intellectual property (such as, for example, a sculpture, painting, movie, game, song, idea, photograph, or written work); a game; an activity; an idea or theory; an object in a augmented/virtual reality environment; another suitable concept; or two or more such concepts. A concept node 304 may be associated with information of a concept provided by a user or information gathered by various systems, including social-networking system. As an example and not by way of limitation, information of a concept may include a name or a title; one or more images (e.g., an image of the cover page of a book); a location (e.g., an address or a geographical location); a website (which may be associated with a URL); contact information (e.g., a phone number or an email address); other suitable concept information; or any suitable combination of such information. In particular embodiments, a concept node 304 may be associated with one or more data objects corresponding to information associated with concept node 304. In particular embodiments, a concept node 304 may correspond to one or more webpages.

In particular embodiments, a node in social graph 300 may represent or be represented by a webpage (which may be referred to as a “profile page”). Profile pages may be hosted by or accessible to a social-networking system. Profile pages may also be hosted on third-party websites associated with a third-party system. As an example and not by way of limitation, a profile page corresponding to a particular external webpage may be the particular external webpage and the profile page may correspond to a particular concept node 304. Profile pages may be viewable by all or a selected subset of other users. As an example and not by way of limitation, a user node 302 may have a corresponding user-profile page in which the corresponding user may add content, make declarations, or otherwise express himself or herself. As another example and not by way of limitation, a concept node 304 may have a corresponding concept-profile page in which one or more users may add content, make declarations, or express themselves, particularly in relation to the concept corresponding to concept node 304.

In particular embodiments, a concept node 304 may represent a third-party webpage or resource hosted by a third-party system. The third-party webpage or resource may include, among other elements, content, a selectable or other icon, or other inter-actable object (which may be implemented, for example, in JavaScript, AJAX, or PHP codes) representing an action or activity. As an example and not by way of limitation, a third-party webpage may include a selectable icon such as “like,” “check-in,” “eat,” “recommend,” or another suitable action or activity. A user viewing the third-party webpage may perform an action by selecting one of the icons (e.g., “check-in”), causing a client system to send to social-networking system a message indicating the user's action. In response to the message, social-networking system may create an edge (e.g., a check-in-type edge) between a user node 302 corresponding to the user and a concept node 304 corresponding to the third-party webpage or resource and store edge 306 in one or more data stores.

In particular embodiments, a pair of nodes in social graph 300 may be connected to each other by one or more edges 306. An edge 306 connecting a pair of nodes may represent a relationship between the pair of nodes. In particular embodiments, an edge 306 may include or represent one or more data objects or attributes corresponding to the relationship between a pair of nodes. As an example and not by way of limitation, a first user may indicate that a second user is a “friend” of the first user. In response to this indication, social-networking system may send a “friend request” to the second user. If the second user confirms the “friend request,” social-networking system may create an edge 306 connecting the first user's user node 302 to the second user's user node 302 in social graph 300 and store edge 306 as social-graph information in one or more of data stores &64. In the example of FIG. 3, social graph 300 includes an edge 306 indicating a friend relation between user nodes 302 of user “A” and user “B” and an edge indicating a friend relation between user nodes 302 of user “C” and user “B.” Although this disclosure describes or illustrates particular edges 306 with particular attributes connecting particular user nodes 302, this disclosure contemplates any suitable edges 306 with any suitable attributes connecting user nodes 302. As an example and not by way of limitation, an edge 306 may represent a friendship, family relationship, business or employment relationship, fan relationship (including, e.g., liking, etc.), follower relationship, visitor relationship (including, e.g., accessing, viewing, checking-in, sharing, etc.), subscriber relationship, superior/subordinate relationship, reciprocal relationship, non-reciprocal relationship, another suitable type of relationship, or two or more such relationships. Moreover, although this disclosure generally describes nodes as being connected, this disclosure also describes users or concepts as being connected. Herein, references to users or concepts being connected may, where appropriate, refer to the nodes corresponding to those users or concepts being connected in social graph 300 by one or more edges 306. The degree of separation between two objects represented by two nodes, respectively, is a count of edges in a shortest path connecting the two nodes in the social graph 300. As an example and not by way of limitation, in the social graph 300, the user node 302 of user “C” is connected to the user node 302 of user “A” via multiple paths including, for example, a first path directly passing through the user node 302 of user “B,” a second path passing through the concept node 304 of company “Acme” and the user node 302 of user “D,” and a third path passing through the user nodes 302 and concept nodes 304 representing school “Stanford,” user “G,” company “Acme,” and user “D.” User “C” and user “A” have a degree of separation of two because the shortest path connecting their corresponding nodes (i.e., the first path) includes two edges 306.

In particular embodiments, an edge 306 between a user node 302 and a concept node 304 may represent a particular action or activity performed by a user associated with user node 302 toward a concept associated with a concept node 304. As an example and not by way of limitation, as illustrated in FIG. 3, a user may “like,” “attended,” “played,” “listened,” “cooked,” “worked at,” or “watched” a concept, each of which may correspond to an edge type or subtype. A concept-profile page corresponding to a concept node 304 may include, for example, a selectable “check in” icon (such as, for example, a clickable “check in” icon) or a selectable “add to favorites” icon. Similarly, after a user clicks these icons, social-networking system may create a “favorite” edge or a “check in” edge in response to a user's action corresponding to a respective action. As another example and not by way of limitation, a user (user “C”) may listen to a particular song using a particular application (e.g., an online music application). In this case, social-networking system may create a “listened” edge 306 and a “used” edge (as illustrated in FIG. 3) between user nodes 302 corresponding to the user and concept nodes 304 corresponding to the song and application to indicate that the user listened to the song and used the application. Moreover, social-networking system may create a “played” edge 306 (as illustrated in FIG. 3) between concept nodes 304 corresponding to the song and the application to indicate that the particular song was played by the particular application. In this case, “played” edge 306 corresponds to an action performed by an external application (e.g., the online music application) on an external audio file (the song). Although this disclosure describes particular edges 306 with particular attributes connecting user nodes 302 and concept nodes 304, this disclosure contemplates any suitable edges 306 with any suitable attributes connecting user nodes 302 and concept nodes 304. Moreover, although this disclosure describes edges between a user node 302 and a concept node 304 representing a single relationship, this disclosure contemplates edges between a user node 302 and a concept node 304 representing one or more relationships. As an example and not by way of limitation, an edge 306 may represent both that a user likes and has used at a particular concept. Alternatively, another edge 306 may represent each type of relationship (or multiples of a single relationship) between a user node 302 and a concept node 304 (as illustrated in FIG. 3 between user node 302 for user “E” and concept node 304 for “Online Music App”).

In particular embodiments, social-networking system may create an edge 306 between a user node 302 and a concept node 304 in social graph 300. As an example and not by way of limitation, a user viewing a concept-profile page (such as, for example, by using a web browser or a special-purpose application hosted by the user's client system) may indicate that he or she likes the concept represented by the concept node 304 by clicking or selecting a “Like” icon, which may cause the user's client system to send to social-networking system a message indicating the user's liking of the concept associated with the concept-profile page. In response to the message, social-networking system may create an edge 306 between user node 302 associated with the user and concept node 304, as illustrated by “like” edge 306 between the user and concept node 304. In particular embodiments, social-networking system may store an edge 306 in one or more data stores. In particular embodiments, an edge 306 may be automatically formed by social-networking system in response to a particular user action. As an example and not by way of limitation, if a first user uploads a picture, watches a movie, or listens to a song, an edge 306 may be formed between user node 302 corresponding to the first user and concept nodes 304 corresponding to those concepts. Although this disclosure describes forming particular edges 306 in particular manners, this disclosure contemplates forming any suitable edges 306 in any suitable manner.

### Social Graph Affinity and Coefficient

In particular embodiments, social-networking system may determine the social-graph affinity (which may be referred to herein as “affinity”) of various social-graph entities for each other. Affinity may represent the strength of a relationship or level of interest between particular objects associated with the online social network, such as users, concepts, content, actions, advertisements, other objects associated with the online social network, or any suitable combination thereof. Affinity may also be determined with respect to objects associated with third-party systems or other suitable systems. An overall affinity for a social-graph entity for each user, subject matter, or type of content may be established. The overall affinity may change based on continued monitoring of the actions or relationships associated with the social-graph entity. Although this disclosure describes determining particular affinities in a particular manner, this disclosure contemplates determining any suitable affinities in any suitable manner.

In particular embodiments, social-networking system may measure or quantify social-graph affinity using an affinity coefficient (which may be referred to herein as “coefficient”). The coefficient may represent or quantify the strength of a relationship between particular objects associated with the online social network. The coefficient may also represent a probability or function that measures a predicted probability that a user will perform a particular action based on the user's interest in the action. In this way, a user's future actions may be predicted based on the user's prior actions, where the coefficient may be calculated at least in part on the history of the user's actions. Coefficients may be used to predict any number of actions, which may be within or outside of the online social network. As an example and not by way of limitation, these actions may include various types of communications, such as sending messages, posting content, or commenting on content; various types of observation actions, such as accessing or viewing profile pages, media, or other suitable content; various types of coincidence information about two or more social-graph entities, such as being in the same group, tagged in the same photograph, checked-in at the same location, or attending the same event; or other suitable actions. Although this disclosure describes measuring affinity in a particular manner, this disclosure contemplates measuring affinity in any suitable manner.

In particular embodiments, social-networking system may use a variety of factors to calculate a coefficient. These factors may include, for example, user actions, types of relationships between objects, location information, other suitable factors, or any combination thereof. In particular embodiments, different factors may be weighted differently when calculating the coefficient. The weights for each factor may be static or the weights may change according to, for example, the user, the type of relationship, the type of action, the user's location, and so forth. Ratings for the factors may be combined according to their weights to determine an overall coefficient for the user. As an example and not by way of limitation, particular user actions may be assigned both a rating and a weight while a relationship associated with the particular user action is assigned a rating and a correlating weight (e.g., so the weights total 100%). To calculate the coefficient of a user towards a particular object, the rating assigned to the user's actions may comprise, for example, 60% of the overall coefficient, while the relationship between the user and the object may comprise 40% of the overall coefficient. In particular embodiments, the social-networking system may consider a variety of variables when determining weights for various factors used to calculate a coefficient, such as, for example, the time since information was accessed, decay factors, frequency of access, relationship to information or relationship to the object about which information was accessed, relationship to social-graph entities connected to the object, short- or long-term averages of user actions, user feedback, other suitable variables, or any combination thereof. As an example and not by way of limitation, a coefficient may include a decay factor that causes the strength of the signal provided by particular actions to decay with time, such that more recent actions are more relevant when calculating the coefficient. The ratings and weights may be continuously updated based on continued tracking of the actions upon which the coefficient is based. Any type of process or algorithm may be employed for assigning, combining, averaging, and so forth the ratings for each factor and the weights assigned to the factors. In particular embodiments, social-networking system may determine coefficients using machine-learning algorithms trained on historical actions and past user responses, or data farmed from users by exposing them to various options and measuring responses. Although this disclosure describes calculating coefficients in a particular manner, this disclosure contemplates calculating coefficients in any suitable manner.

In particular embodiments, social-networking system may calculate a coefficient based on a user's actions. Social-networking system may monitor such actions on the online social network, on a third-party system, on other suitable systems, or any combination thereof. Any suitable type of user actions may be tracked or monitored. Typical user actions include viewing profile pages, creating or posting content, interacting with content, tagging or being tagged in images, joining groups, listing and confirming attendance at events, checking-in at locations, liking particular pages, creating pages, and performing other tasks that facilitate social action. In particular embodiments, social-networking system may calculate a coefficient based on the user's actions with particular types of content. The content may be associated with the online social network, a third-party system, or another suitable system. The content may include users, profile pages, posts, news stories, headlines, instant messages, chat room conversations, emails, advertisements, pictures, video, music, other suitable objects, or any combination thereof. Social-networking system may analyze a user's actions to determine whether one or more of the actions indicate an affinity for subject matter, content, other users, and so forth. As an example and not by way of limitation, if a user frequently posts content related to “coffee” or variants thereof, social-networking system may determine the user has a high coefficient with respect to the concept “coffee”. Particular actions or types of actions may be assigned a higher weight and/or rating than other actions, which may affect the overall calculated coefficient. As an example and not by way of limitation, if a first user emails a second user, the weight or the rating for the action may be higher than if the first user simply views the user-profile page for the second user.

In particular embodiments, social-networking system may calculate a coefficient based on the type of relationship between particular objects. Referencing the social graph 300, social-networking system may analyze the number and/or type of edges 306 connecting particular user nodes 302 and concept nodes 304 when calculating a coefficient. As an example and not by way of limitation, user nodes 302 that are connected by a spouse-type edge (representing that the two users are married) may be assigned a higher coefficient than a user nodes 302 that are connected by a friend-type edge. In other words, depending upon the weights assigned to the actions and relationships for the particular user, the overall affinity may be determined to be higher for content about the user's spouse than for content about the user's friend. In particular embodiments, the relationships a user has with another object may affect the weights and/or the ratings of the user's actions with respect to calculating the coefficient for that object. As an example and not by way of limitation, if a user is tagged in a first photo, but merely likes a second photo, social-networking system may determine that the user has a higher coefficient with respect to the first photo than the second photo because having a tagged-in-type relationship with content may be assigned a higher weight and/or rating than having a like-type relationship with content. In particular embodiments, social-networking system may calculate a coefficient for a first user based on the relationship one or more second users have with a particular object. In other words, the connections and coefficients other users have with an object may affect the first user's coefficient for the object. As an example and not by way of limitation, if a first user is connected to or has a high coefficient for one or more second users, and those second users are connected to or have a high coefficient for a particular object, social-networking system may determine that the first user should also have a relatively high coefficient for the particular object. In particular embodiments, the coefficient may be based on the degree of separation between particular objects. The lower coefficient may represent the decreasing likelihood that the first user will share an interest in content objects of the user that is indirectly connected to the first user in the social graph 300. As an example and not by way of limitation, social-graph entities that are closer in the social graph 300 (i.e., fewer degrees of separation) may have a higher coefficient than entities that are further apart in the social graph 300.

In particular embodiments, social-networking system may calculate a coefficient based on location information. Objects that are geographically closer to each other may be considered to be more related or of more interest to each other than more distant objects. In particular embodiments, the coefficient of a user towards a particular object may be based on the proximity of the object's location to a current location associated with the user (or the location of a client system of the user). A first user may be more interested in other users or concepts that are closer to the first user. As an example and not by way of limitation, if a user is one mile from an airport and two miles from a gas station, social-networking system may determine that the user has a higher coefficient for the airport than the gas station based on the proximity of the airport to the user.

In particular embodiments, social-networking system may perform particular actions with respect to a user based on coefficient information. Coefficients may be used to predict whether a user will perform a particular action based on the user's interest in the action. A coefficient may be used when generating or presenting any type of objects to a user, such as advertisements, search results, news stories, media, messages, notifications, or other suitable objects. The coefficient may also be utilized to rank and order such objects, as appropriate. In this way, social-networking system may provide information that is relevant to user's interests and current circumstances, increasing the likelihood that they will find such information of interest. In particular embodiments, social-networking system may generate content based on coefficient information. Content objects may be provided or selected based on coefficients specific to a user. As an example and not by way of limitation, the coefficient may be used to generate media for the user, where the user may be presented with media for which the user has a high overall coefficient with respect to the media object. As another example and not by way of limitation, the coefficient may be used to generate advertisements for the user, where the user may be presented with advertisements for which the user has a high overall coefficient with respect to the advertised object. In particular embodiments, social-networking system may generate search results based on coefficient information. Search results for a particular user may be scored or ranked based on the coefficient associated with the search results with respect to the querying user. As an example and not by way of limitation, search results corresponding to objects with higher coefficients may be ranked higher on a search-results page than results corresponding to objects having lower coefficients.

In particular embodiments, social-networking system may calculate a coefficient in response to a request for a coefficient from a particular system or process. To predict the likely actions a user may take (or may be the subject of) in a given situation, any process may request a calculated coefficient for a user. The request may also include a set of weights to use for various factors used to calculate the coefficient. This request may come from a process running on the online social network, from a third-party system (e.g., via an API or other communication channel), or from another suitable system. In response to the request, social-networking system may calculate the coefficient (or access the coefficient information if it has previously been calculated and stored). In particular embodiments, social-networking system may measure an affinity with respect to a particular process. Different processes (both internal and external to the online social network) may request a coefficient for a particular object or set of objects. Social-networking system may provide a measure of affinity that is relevant to the particular process that requested the measure of affinity. In this way, each process receives a measure of affinity that is tailored for the different context in which the process will use the measure of affinity.

In connection with social-graph affinity and affinity coefficients, particular embodiments may utilize one or more systems, components, elements, functions, methods, operations, or steps disclosed in U.S. patent application Ser. No. 11/503,093, filed 11 Aug. 2006, U.S. patent application Ser. No. 12/977,027, filed 22 Dec. 2010, U.S. patent application Ser. No. 12/978,265, filed 23 Dec. 2010, and U.S. patent application Ser. No. 13/632,869, filed 1 Oct. 2012, each of which is incorporated by reference.

### Systems and Methods

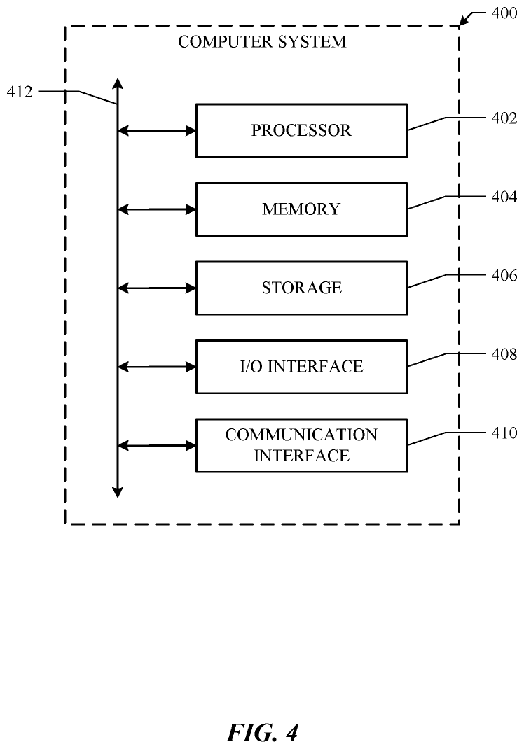

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

[51] The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

1. A method comprising, by one or more computing systems:
receiving, from each of a plurality of third-party systems, an augmented-reality object and an associated display rule;
receiving, from a client system associated with a first user, one or more signals associated with a current view of an environment of the first user;
selecting at least one of the augmented-reality objects received from the plurality of third-party systems based on (1) the one or more signals, (2) a way the first user is likely to interact with the selected augmented-reality object, and (3) the display rule associated with the selected augmented-reality object; and
sending, to the client system, instructions for presenting the selected augmented-reality object with the current view of the environment.

2. The method of claim 1, wherein the one or more signals comprise one or more of:
location information of the environment;
social graph information associated with the environment;
social graph information associated with the first user;
contextual information associated with the environment; or
time information.

3. The method of claim 1, wherein each of the plurality of third-party systems is associated with a third-party content provider.

4. The method of claim 3, wherein each third-party content provider is registered to the one or more computing systems.

5. The method of claim 1, further comprising:
generating, for each of the plurality of third-party systems, a declarative model; and
receiving, via the declarative model from the corresponding third-party system, one or more preferences for one or more types of augmented-reality objects.

6. The method of claim 5, wherein selecting the at least one of the augmented-reality objects received from the plurality of third-party systems is further based on the one or more preferences received from each third-party system.

7. The method of claim 1, further comprising:
generating, for at least one of the plurality of third-party systems, a discovery model; and
sending, to the client system, a prompt via the discovery model, wherein the prompt comprises an executable link for installing a third-party application associated with the at least one third-party system.

8. The method of claim 1, further comprising:
receiving, from the client system, one or more user interactions with the selected augmented-reality object from the first user.

9. The method of claim 1, wherein the augmented-reality object comprises one or more of an interactive digital element, a visual overlay, or a sensory projection.

10. One or more computer-readable non-transitory storage media embodying software that is operable when executed to:
receive, from each of a plurality of third-party systems, an augmented-reality object and an associated display rule;
receive, from a client system associated with a first user, one or more signals associated with a current view of an environment of the first user;
select at least one of the augmented-reality objects received from the plurality of third-party systems based on (1) the one or more signals, (2) a way the first user is likely to interact with the selected augmented-reality object, and (3) the display rule associated with the selected augmented-reality object; and
send, to the client system, instructions for presenting the selected augmented-reality object with the current view of the environment.

11. The media of claim 10, wherein the one or more signals comprise one or more of:
location information of the environment;
social graph information associated with the environment;
social graph information associated with the first user;
contextual information associated with the environment; or
time information.

12. The media of claim 10, wherein each of the plurality of third-party systems is associated with a third-party content provider.

13. The media of claim 12, wherein each third-party content provider is registered to the one or more computing systems.

14. The media of claim 10, wherein the software is further operable when executed to:
generate, for each of the plurality of third-party systems, a declarative model; and
receive, via the declarative model from the corresponding third-party system, one or more preferences for one or more types of augmented-reality objects.

15. The media of claim 14, wherein selecting the at least one of the augmented-reality objects received from the plurality of third-party systems is further based on the one or more preferences received from each third-party system.

16. The media of claim 10, wherein the software is further operable when executed to:
generate, for at least one of the plurality of third-party systems, a discovery model; and
send, to the client system, a prompt via the discovery model, wherein the prompt comprises an executable link for installing a third-party application associated with the at least one third-party system.

17. The media of claim 10, wherein the software is further operable when executed to:
receive, from the client system, one or more user interactions with the selected augmented-reality object from the first user.

18. The media of claim 10, wherein the augmented-reality object comprises one or more of an interactive digital element, a visual overlay, or a sensory projection.

19. A system comprising: one or more processors; and a non-transitory memory coupled to the processors comprising instructions executable by the processors, the processors operable when executing the instructions to:
receive, from each of a plurality of third-party systems, an augmented-reality object and an associated display rule;
receive, from a client system associated with a first user, one or more signals associated with a current view of an environment of the first user;
select at least one of the augmented-reality objects received from the plurality of third-party systems based on (1) the one or more signals, (2) a way the first user is likely to interact with the selected augmented-reality object, and (3) the display rule associated with the selected augmented-reality object; and
send, to the client system, instructions for presenting the selected augmented-reality object with the current view of the environment.

20. The system of claim 19, wherein the one or more signals comprise one or more of:
location information of the environment;
social graph information associated with the environment;
social graph information associated with the first user;
contextual information associated with the environment; or
time information.
